SEQUENCE LISTING (38 sequences)

SEQ ID NO: 1 - DNA, 41 bp, Artificial Sequence
  Sequencing Primer
ccactacgcctccgctttcctctctatgggcagtcggtgat

SEQ ID NO: 2 - DNA, 24 bp, Artificial Sequence
  Bridging Oligonucleotide
gtgagcttcagatcaccgactgcn

SEQ ID NO: 3 - DNA, 10 bp, Artificial Sequence
  Ligation Oligonucleotide
ctgaagctca

SEQ ID NO: 4 - DNA, 24 bp, Artificial Sequence
  Ligation Oligonucleotide
gtgagcttcagatcaccgactgcn

SEQ ID NO: 5 - DNA, 11 bp, Artificial Sequence
  Capping Oligonucleotide
ctgaagctcan

SEQ ID NO: 6 - DNA, 9 bp, Artificial Sequence
  Degenerate Base Oligonucleotide
nnnnnnnnn

SEQ ID NO: 7 - DNA, 91 bp, Artificial Sequence
  cDNA Sequencing Construct
ccactacgcctccgctttcctctctatgggcagtcggtgatctgaagctcatgnnnnnnnnnnagagaatgaggaacccggggcagttcac

SEQ ID NO: 8 - DNA, 53 bp, Artificial Sequence
  Linker Oligonucleotide
ccactacgcctccgctttcctctctatgggcagtcggtgatctgaagctcatg

SEQ ID NO: 9 - DNA, 49 bp, Artificial Sequence
  Linker Oligonucleotide
agcttcagatcaccgactgcccatagagaggaaagcggaggcgtagtgg

SEQ ID NO: 10 - DNA, 27 bp, Artificial Sequence
  Linker Oligonucleotide
aactgccccgggttcctcattctctnn

SEQ ID NO: 11 - DNA, 25 bp, Artificial Sequence
  Linker Oligonucleotide
agagaatgaggaacccggggcagtt

SEQ ID NO: 12 - DNA, 28 bp, Artificial Sequence
  Amplification Primer
ccactacgcctccgctttcctctctatg

SEQ ID NO: 13 - DNA, 26 bp, Artificial Sequence
  Amplification Primer
gtgaactgccccgggttcctcattct

SEQ ID NO: 14 - DNA, 41 bp, Artificial Sequence
  Hybridization Oligonucleotide
ccactacgccaccgctttcctctctatgggcagtcggtgat

SEQ ID NO: 15 - DNA, 41 bp, Artificial Sequence
  Hybridization Oligonucleotide
cccagtcttcactcagcccctctctatgggcagtcggtgat

SEQ ID NO: 16 - DNA, 41 bp, Artificial Sequence; identical to SEQ ID NO: 14
  Emulsion PCR Oligonucleotide Primer

SEQ ID NO: 17 - DNA, 23 bp, Artificial Sequence
  Emulsion PCR Oligonucleotide Primer
cctctctatgggcagtcggtgat

SEQ ID NO: 18 - DNA, 23 bp, Artificial Sequence
  Emulsion PCR Oligonucleotide Primer
ctgccccgggttcctcattctct

SEQ ID NO: 19 - DNA, 17 bp, Artificial Sequence
  Library-Specific Oligonucleotide
aaagcggnggcgnagng

SEQ ID NO: 20 - DNA, 17 bp, Artificial Sequence
  Library-Specific Oligonucleotide
ggcngagngaagacngg

SEQ ID NO: 21 - DNA, 17 bp, Artificial Sequence
  Sequencing Oligonucleotide
aaagcggnggcgnagng

SEQ ID NO: 22 - DNA, 22 bp, Artificial Sequence
  Sequencing Oligonucleotide
canngagcnncaganncaccga

SEQ ID NO: 23 - DNA, 20 bp, Artificial Sequence
  Sequencing Oligonucleotide
cccgggnnccncannncnct

SEQ ID NO: 24 - DNA, 19 bp, Artificial Sequence
  Sequencing Oligonucleotide
cnncagancaccgacngcn

SEQ ID NO: 25 - DNA, 16 bp, Artificial Sequence
  Sequencing Oligonucleotide
cngccccgggnnccnn

SEQ ID NO: 26 - DNA, 10 bp, Artificial Sequence
  Capping Oligonucleotide
ctgaagctca

SEQ ID NO: 27 - DNA, 25 bp, Artificial Sequence
  Bridging Oligonucleotide
gngagctncagancaccgacngcnn

SEQ ID NO: 28 - DNA, 27 bp, Artificial Sequence
  Bridging Oligonucleotide
gngagctncagtcngccccgggntcnn

SEQ ID NO: 29 - DNA, 20 bp, Artificial Sequence
  Anchor Oligonucleotide
cangagcnncagancaccga

SEQ ID NO: 30 - DNA, 19 bp, Artificial Sequence
  Anchor Oligonucleotide
cccgggnnccncanncnct

SEQ ID NO: 31 - DNA, 20 bp, Artificial Sequence
  Blocking Oligonucleotide
cnncagancaccgacngcnn

SEQ ID NO: 32 - DNA, 17 bp, Artificial Sequence
  Blocking Oligonucleotide
cngccccgggnnccnnn

SEQ ID NO: 33 - DNA, 9 bp, Artificial Sequence
  Query Oligonucleotide
nnnntnnnn

SEQ ID NO: 34 - DNA, 9 bp, Artificial Sequence
  Query Oligonucleotide
nnnnannnn

SEQ ID NO: 35 - DNA, 9 bp, Artificial Sequence
  Query Oligonucleotide
nnnncnnnn

SEQ ID NO: 36 - DNA, 9 bp, Artificial Sequence
  Query Oligonucleotide
nnnngnnnn

SEQ ID NO: 37 - DNA, 9 bp, Artificial Sequence
  Query Nonamer
aaaaaaaaa

SEQ ID NO: 38 - DNA, 9 bp, Artificial Sequence
  Query Nonamer
ggggggggg

(19) United States
(12) Patent Application Publication
(10) Pub. No.: US 2009/0318298 A1
(43) Pub. Date: Dec. 24, 2009

(54) Methods for Sequencing DNA

(75) Inventors: Jae B. Kim, Thousand Oaks, CA (US); Gregory J. Porreca, Cambridge, MA (US); George M. Church, Brookline, MA (US); Jonathan G. Seidman, Milton, MA (US)

Correspondence Address: BANNER & WITCOFF, LTD., 28 STATE STREET, SUITE 1800, BOSTON, MA, 02109-1701, US

(73) Assignees: President and Fellows of Harvard College, Cambridge, MA (US); Brigham and Women's Hospital, Inc., Boston, MA (US)

(21) Appl. No.: 12/412,471

(22) Filed: Mar. 27, 2009

Related U.S. Application Data
(63) Continuation of application No. PCT/US2007/079936, filed on Sep. 28, 2007.
(60) Provisional application No. 60/847,752, filed on Sep. 28, 2006.

(51) Int. Cl. C40B 20/00; C40B 40/08; C40B 50/18

(52) U.S. Cl. 506/2; 506/17; 506/32

(57) ABSTRACT

The invention is directed to methods for using sequence by ligation to sequence DNA immobilized on miniaturized, high density bead-based arrays. Methods are provided to fabricate an array of beads where the beads are coupled directly to a solid support. Methods are also provided to improve signal and reduce background in ligation-mediated DNA sequencing. In addition, methods are provided to improve the accuracy of reported tag counts when performing DNA sequencing by fluorescent nonamer ligation.

### RELATED APPLICATION

This application is a continuation of PCT Application No. PCT/U.S.07/79936 designating the United States and filed Sep. 28, 2007; which claims the benefit of the filing date of U.S. Provisional Patent Application No. 60/847,752 filed on Sep. 28, 2006; each of which is hereby incorporated herein by reference in its entirety for all purposes.

### STATEMENT OF GOVERNMENT INTERESTS

This invention was made with U.S. Government support under grant number HG003170 awarded by the National Institutes of Health. The Government has certain rights in the invention.

### FIELD

This invention relates generally to methods for sequencing DNA, and in particular, to methods for using sequence by ligation to sequence DNA immobilized on miniaturized, high density bead-based arrays.

### BACKGROUND

Profiling mRNA populations is an effective way to investigate cellular or tissue responses and classify into cellular types. Modalities currently available for assessing genome-wide gene expression have proven to be insensitive for the comprehensive assessment of important but rare mRNA molecules such as transcription factors. Serial analysis of gene expression (SAGE) utilizes Sanger dideoxy chemistry to sequence concatenated, PCR amplified cDNA tags. There are several limitations to SAGE, such as the high cost per tag, and skewing of mRNA counts attributable to PCR amplification of tag products prior to cloning and sequencing.

Polymerase colony (polony) bead DNA sequencing is an inexpensive, accurate, rapid approach to sequencing DNA. Polony multiplex analysis of gene expression (PMAGE) using polony bead DNA sequencing permits accurate quantitative assessment of mRNA expression. In general, the method relies on a biochemical procedure, sequencing by degenerate fluorescent ligation, to tag each bead with a fluorophore encoding the identity of a base within the template. As with SAGE tags, PMAGE tags can be quantified, subjected to rigorous statistical analysis, and assigned its cognate gene identity by standard database algorithms. This approach has the further advantages of having a yield of data that is orders of magnitude greater than with SAGE at a fraction of the cost.

However, it may be challenging under certain circumstances to achieve accurate quantitative assessments of mRNA abundance because of difficulties in attaining high yields of data, attaining a high degree of accuracy in the sequencing chemistry, and decreasing systematic bias of tag data.

Polony bead DNA sequencing may be conventionally performed on an array of beads (200-1000 nm in diameter, coated with oligonucleotides) embedded in an acrylamide matrix. While this serves the essential purpose of immobilizing the beads, it may also introduce significant complications. The gel may interfere with access to the bead-bound DNA templates by sequencing reagents due to limited diffusion. Acrylamide gel may be susceptible to attack by alkali, or dehydration may limit the reagents which are used during sequencing cycles (e.g. alcohols, alkaline denaturants, etc. cannot be used). During the course of a sequencing run, fluorescent reagents and contaminants may stick to the gel causing loss of reads. The acrylamide layer is not absolutely flat, and the beads within the gel are not uniformly in the same focal plane, hence focusing on the beads during sequencing may be problematic resulting in a loss of yield and sequencing fidelity. In addition, fluorescence background may accumulate on DNA-bearing beads as the sequencing run progresses. The accumulation is the result of covalent addition of fluorescent species to free 3′ hydroxyl ends of templates and un-extended bead-bound amplification primers. Further, increasing concentrations of beads may lead to clumping, which can confound data acquisition due to clumps of beads landing on different focal planes.

Current protocols in Polony DNA sequencing and other methods of sequencing DNA by ligation include a ‘capping’ step where the array is incubated in the presence of terminal deoxytransferase and dideoxynucleotides. While the expectation is that the enzyme will add a dideoxynucleotide to the 3′ end of each DNA strand, some ends may not be capped and may still be free to participate in polymerization and ligation reactions, which over several sequencing cycles can result in the development of significant background signal.

When performing sequencing by fluorescent nonamer ligation for expression profiling, large deviations from expected tag counts can occur because of sequence-specific systematic biases in the efficiency of the ligation reaction. These biases, while reproducible from run to run, can cause the frequency of a significant number of tags to be under-represented during analysis.

### SUMMARY

The present invention is based in part on the discovery of novel materials and methods for increasing bead density on the array, improving signal, reducing background, enhancing the efficiency of ligation, and improving the accuracy of reported tag counts when performing DNA sequencing.

Certain aspects of the present invention are directed to bead-based arrays. In accordance with certain exemplary embodiments, an array is provided having a plurality of beads and a solid support. Each bead of the plurality has oligonucleotides immobilized on the surface of the bead. Each bead is connected to the solid support by at least one molecule on the bead which can bind to a corresponding molecule on a surface of the solid support.

Other aspects of the present invention are directed to methods for making bead-based arrays. In accordance with certain exemplary embodiments, a method for producing an array includes providing a plurality of beads and a solid support, and connecting the plurality of beads to the solid support by binding at least one molecule on a bead to a corresponding molecule on a surface of the solid support. Each bead of the plurality has oligonucleotides immobilized on the surface of the bead,

Other aspects of the present invention are directed to methods for using bead-based arrays. In accordance with certain exemplary embodiments, a method is provided for DNA sequencing. A plurality of beads is provided, wherein each bead has immobilized on the surface thereof single-stranded template DNA having a 3′ terminus. A first oligonucleotide having a 5′ overhanging sequence is annealed to the 3′ terminus of the template DNA. Then, a second oligonucleotide having a 3′ blocking moiety is annealed to the 5′ overhanging sequence, and the second oligonucleotide is ligated to the template DNA. An array is formed by connecting the plurality of beads to a solid support. Finally, DNA sequencing is preformed on the array.

The patent or application file contains at least one drawing executed in color. Copies of this patent or patent application publication with color drawing(s) will be provided by the Office upon request and payment of the necessary fee. The foregoing and other features and advantages of the present invention will be more fully understood from the following detailed description of illustrative embodiments taken in conjunction with the accompanying drawings.

### BRIEF DESCRIPTION OF THE DRAWINGS

FIG. 1 depicts methods for binding polony beads to a solid support. A) Initial methods involved beads embedded in an acrylamide gel. B) An embodiment of the present invention involves polony beads bound directly to the solid support. C) Oligonucleotides on the surface of the polony beads have an NH₂ group on their 3′ end, which is linked to an active NH₂ group on siliconized glass. The two NH₂ groups are linked by bis(sulfosuccinimidyl) suberate (BS3).

FIG. 2 depicts a comparative polony array made in acrylamide gel. Polony beads settle into different focal planes, limiting bead concentration and data processing.

FIG. 3 depicts an embodiment of the present invention: a gel-less array with polony beads bound directly onto amino silylated glass using 3′ NH₂ terminated oligonucleotide covered beads and BS3 as a crosslinker.

FIG. 4 depicts a typical tetrahedron plot of fluorescence data from a sequencing cycle performed on a comparative gel-based polony bead array. Each point represents a single polony bead, and the four clusters represent the four possible bases.

FIG. 5 depicts a typical tetrahedron plot of fluorescence data from a sequencing cycle performed on a gel-less polony bead array disclosed herein. The same position was queried using identical thresholds as the tetrahedron in FIG. 4. A single focal plane and increased sequencing reagent access improved signal coherence compared to FIG. 4. Sources of variation such as having beads in different focal planes and limited sequencing reagent diffusion through a gel matrix have been removed.

FIG. 6 depicts DNA sequencing by ligation. A) The normal reaction involves annealing three DNA fragments: one fragment bound to solid support (yellow bar, also called template DNA); one fragment being a sequencing primer (gray bar) and one fragment being a degenerate oligonucleotide with a fluorescent tag (gray bar with red circle, also called a query probe), and then ligating the primer and the tagged fragments with DNA ligase. B) A troublesome side reaction involves ligation of the tagged query probe to solid support bound oligonucleotide. This side reaction results in irreversible accumulation of nonspecific fluorescent background, which degrades sequencing fidelity. C) A capping reaction is performed preceding ligation mediated sequencing by blocking the 3′ terminii (capping solid support bound oligonucleotide with a 3′ dideoxycytidine or 3′ primary amino modification—green star) and prevents subsequent ligations at the 3′ end of the solid support bound oligonucleotide. In addition, capping provides a reactive functional group which can be used to directly attach the polony beads to a solid support.

FIG. 7 depicts capping efficiency of terminal deoxynucleotidyl transferase compared with capping by ligation. A) Brightfield imaging of polony beads. B) Forward primer (5′CCACTACGCCTCCGCTTTCCTCTCTATGGGCAGTCGGTGAT3′) loaded polony beads annealed with a bridging oligo (5′GTGAGCTTCAGATCACCGACTGC/3ddC/3′), then subjected to ligation with a 3′Cy3 terminated oligonucleotide (5′/5Phos/CTGAAGCTCA/3Cy3Sp/3′) demonstrated the potential for unwanted irreversible fluorescence background attributable to free 3′OH ends of DNA bound to beads. C) The above experiment performed in parallel after pre-treatment of primer loaded polony beads with terminal deoxynucleotidyl transferase (Tdt) and dideoxynucleotides for 1 hour. There is still significant background fluorescence. D) Noticeably reduced background fluorescence is appreciated when the same ligation reaction is performed with primer loaded polony beads that are first capped by ligation in PEG (annealing oligo 5′GTGAGCTTCAGATCACCGACTGC/3ddC/3′, capping oligo 5′/5Phos/CTGAAGCTCA/3ddC/3′). The reduced background fluorescence reflects improved efficacy of the capping-by ligation strategy.

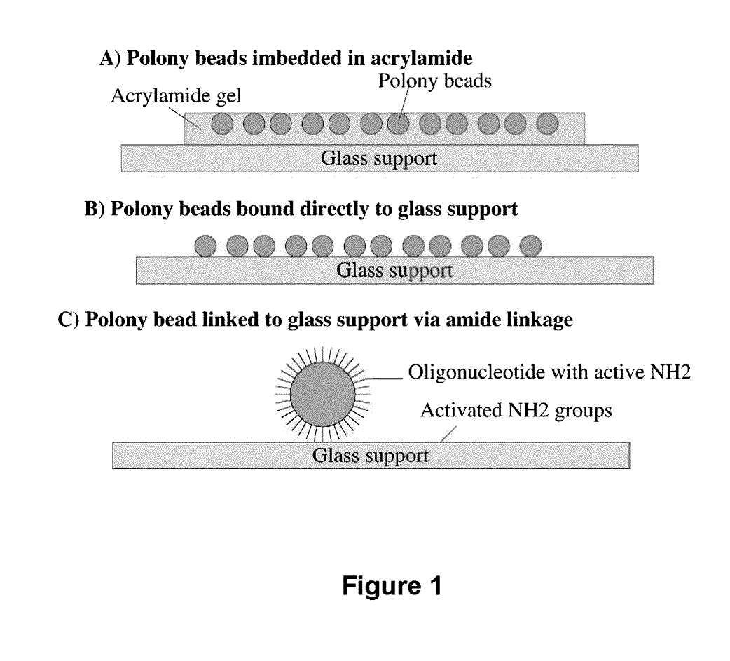

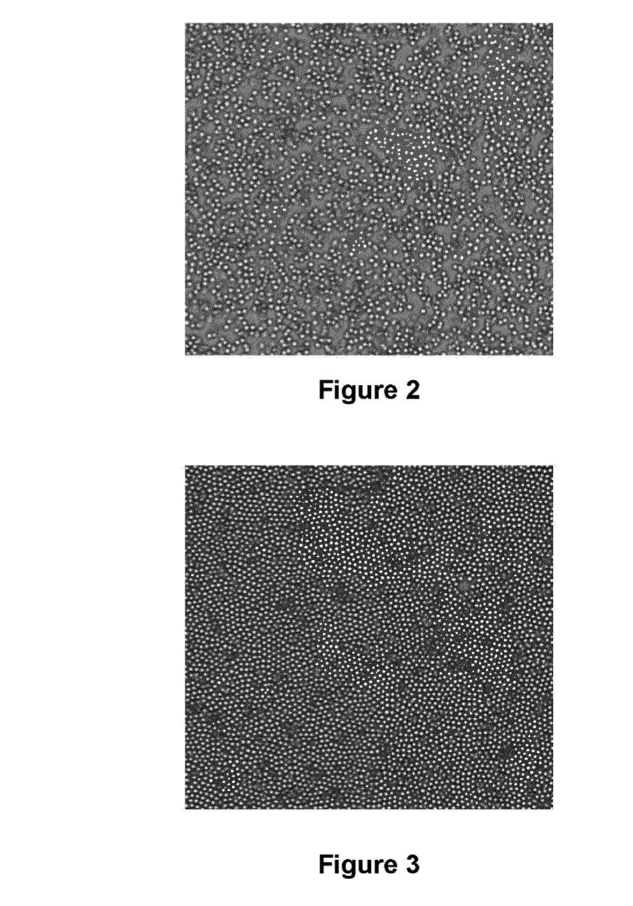

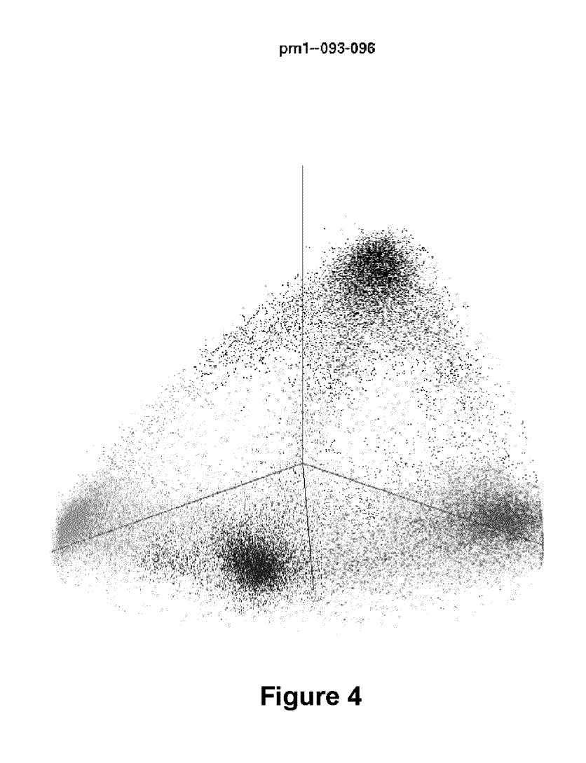

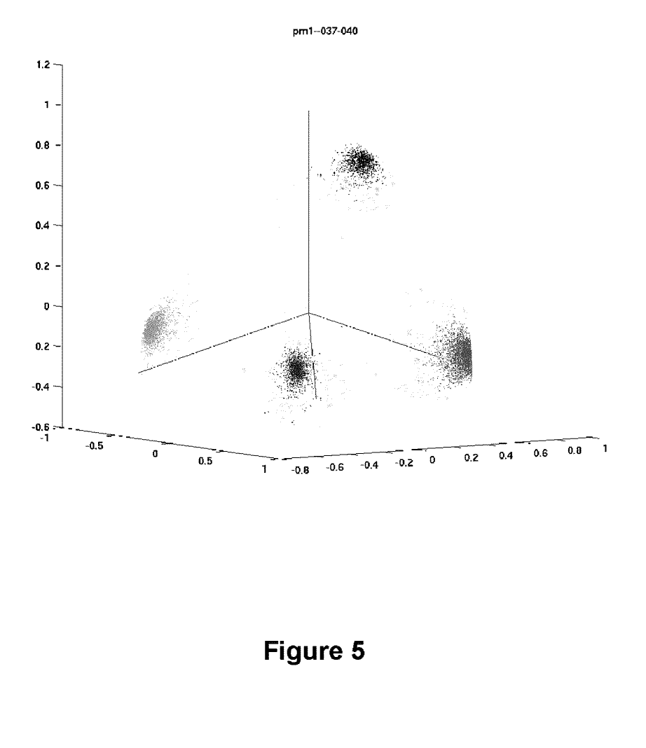

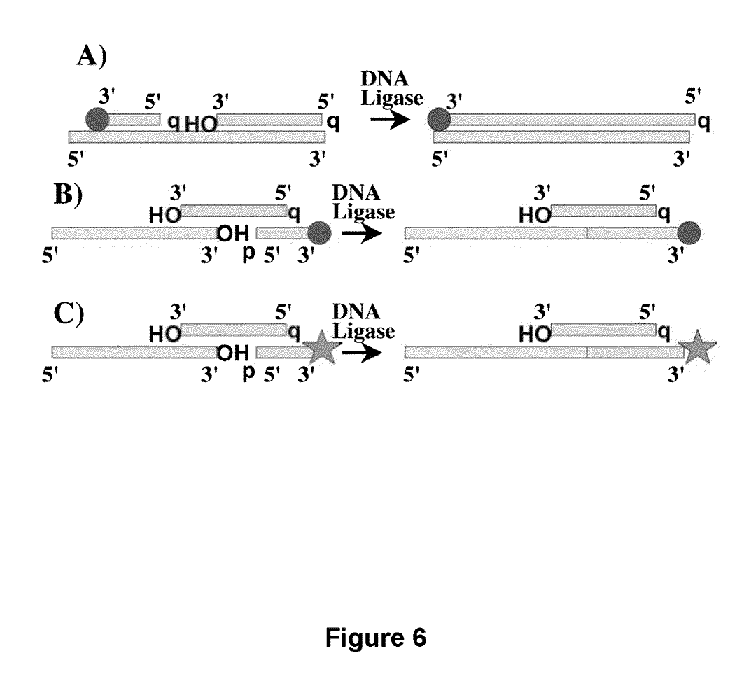

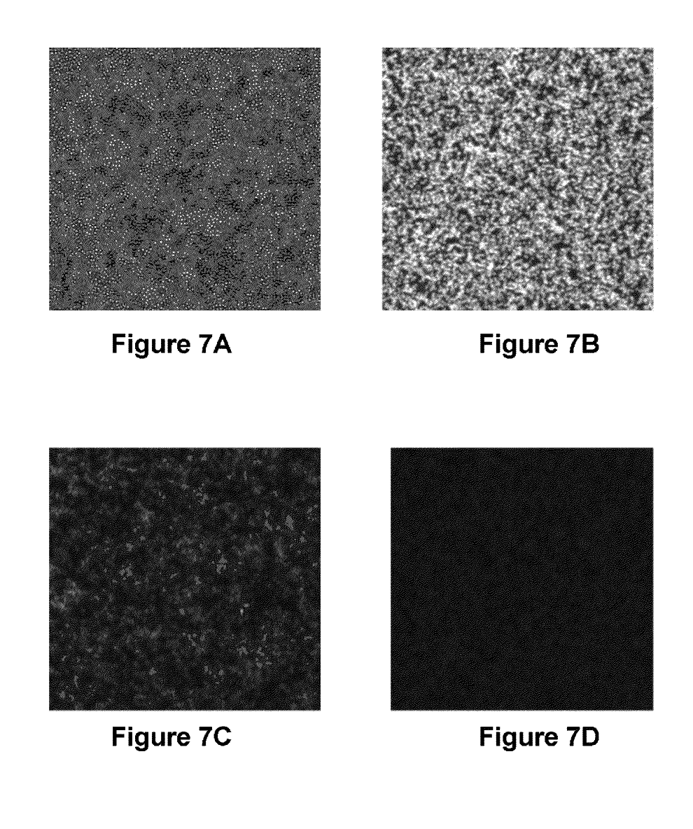

### DETAILED DESCRIPTION

Embodiments of the present invention include aspects of methods and techniques of immobilizing polymerase colonies (polonies) onto miniaturized, high density bead-based arrays for DNA sequencing described in, for example PCT/US05/06425 and U.S. patent application Ser. No. 11/505,073, incorporated herein by reference in their entirety for all purposes.

Embodiments of the present invention also include aspects of methods and techniques for utilizing a sequence by ligation approach on multiplexed polonies to achieve the sequencing of millions of oligonucleotide cDNA tags per experiment, for example Shendure et al. (2005) Science, Vol. 309. No. 5741, pp. 1728-1732, incorporated herein by reference in its entirety for all purposes. This technique is called PMAGE (Polony Multiplex Analysis of Gene Expression).

Embodiments of the present invention are particularly directed to bead-based arrays where beads are directly coupled to a solid support. According to one embodiment, the beads are immobilized to a substrate surface via a tether molecule, including molecules having linker moieties, that are covalently attached to both the substrate surface and the bead. According to the present invention the bead can include a molecule which can bind to a corresponding molecule on the surface of the solid support thereby connecting the bead to the solid support. According to one embodiment, the molecule on the bead binds non-covalently to the corresponding molecule on the surface of the solid support. Examples of non-covalent binding molecules include streptavidin and biotin. The beads are arranged in a uniform layer of preferably one bead thickness. These bead-based arrays can then be used in and/or with the methods described in the above DNA sequencing methods, i.e. PCT/US05/06425, U.S. patent application Ser. No. 11/505,073, Shendure et al. (2005) Science, Vol. 309. No. 5741, pp. 1728-1732, the entire disclosures of which are incorporated herein by reference and for all purposes. The support can be glass, metal, ceramic, or plastic solid phase and the like. The support can be either flat or contoured.

In certain embodiments, polony beads are bound directly to a glass support by linkage of the 3′ ends of the oligonucleotides immobilized on the beads to activated —NH₂ groups on the siliconized glass support. Linkages can include amino ester linkages, asymmetric linkages, e.g., N-(κ-maleimidoundecanoyloxy)sulfosuccinimidyl (KMUS), N-(ε-maleimidocaproyloxy)succinimidyl (EMCS), N-hydroxy-succimidyl (for RNH₂ functional groups), and iodoacetamidyl (for RSH functional groups), and cleavable or reversible linkages such as dithiol or nitrobenzyl, and the like. In certain embodiments, a glass support is provided, such as, for example, a glass slide or a glass coverslip, which is coated with a hydrophilic polymer. The hydrophilic polymer acts as a tether molecule between the bead and the support. The hydrophilic polymer, or tether molecule, can be polyethylene glycol, poly(N-vinyl lactams), polysaccharides, polyacrylates, polyacrylamides, polyalkylene oxides, and copolymers of any of them. Each polymer is covalently attached at one end to the glass support, and bears a linker functional group at the other end. Beads having oligonucleotides with a 3′-NH₂ group as described herein are bound to the glass substrate by covalently attaching the 3′-NH₂ group to the linker function group. The linker can include amino esters, bis(sulfosuccinimidyl) suberate (BS3), N-hydroxysuccinimidyl (NHS), N-(κ-maleimidoundecanoyloxy)sulfosuccinimidyl (KMUS), N-(ε-maleimidocaproyloxy)succinimidyl (EMCS), iodoacetamide, dithiol, nitrobenzyl, and mixtures of any of them.

In accordance with another aspect of the invention, methods for producing an array are provided. Polony beads, each having a polony of oligonucleotides immobilized on the surface of the bead are directly coupled or connected to the surface of a solid support by binding at least one molecule on a bead to a corresponding molecule on a surface of the solid support. In certain embodiments, this can be done by reacting a tether molecule as described herein with the surface of the solid support and with an oligonucleotide immobilized on a bead to covalently attach the bead to the glass support. In other embodiments, a glass support is provided having tether molecules already covalently attached to the surface of the glass support. The tether molecules can be polyethylene glycol, poly(N-vinyl lactams), polysaccharides, polyacrylates, polyacrylamides, polyalkylene oxides, and copolymers of any of them. The tether molecules each beard a linker functional group which can be reacted with an oligonucleotide immobilized on a bead to covalently attach the bead to the glass support. The linker function group can include amino esters, bis(sulfosuccinimidyl)suberate (BS3), N-hydroxysuccinimidyl (NHS), N-κ-aleimidoundecanoyloxy)sulfosuccinimidyl (KMUS), N-(ε-maleimidocaproyloxy)succinimidyl (EMCS), iodoacetamide, dithiol, nitrobenzyl, and mixtures of any of them.

In certain embodiments, a method of sequence-specific enrichment for amplified beads from a mixed population of empty and amplified beads is provided by ligation of a capture probe and coupling of the capture probe to the glass support to which the beads are to be attached.

In accordance with another aspect of the invention, methods to improve signal and reduce background in polony ligation-mediated DNA sequencing are provided. Certain embodiments are directed to methods for capping the 3′ terminii of single-stranded template DNA that are bound to beads to block further participation in ligation reactions. According to embodiments of the present invention, a first oligonucleotide having a 5′ overhanging sequence is annealed to the 3′ terminus of the single-stranded template DNA. A second oligonucleotide complementary to the 5′ overhanging sequence and containing a 3′ blocking moiety is annealed to the first oligonucleotide. The second oligonucleotide is ligated to the template DNA. The 3′ blocking moiety can include an amino-modifier, a dideoxycytidine, a non-ribose, a covalent blocking group, a steric blocking group, or a reversible blocking group and the like. The 3′ amino modifier can be used to attach the DNA-coated beads to glass by NHS ester chemistry. The oligonucleotides may be composed of degenerate bases, such as 5′-/5Phos/NNNNNNNNN/3AmM/-3′.

Other embodiments are directed to reducing background by removing free forward primer from the beads after coupling to the array in a sequence-specific manner. According to certain embodiments, one method includes the steps of annealing a protecting oligonucleotide of complementary sequence to the 3′ end of the DNA strands which should not be removed, incubating the DNA on the beads with Exonuclease I under conditions suitable for 3′ to 5′ exonucleolysis, and inactivating and removing the Exonuclease I.

Another aspect of the invention is directed to enhancing the efficiency of the ligation reaction for either sequencing by ligation or for capping the 3′ terminii of single-stranded template DNA by addition of polyethylene glycol to the ligation reaction.

In another aspect of the invention, methods to improve the accuracy of reported tag counts when performing DNA sequencing by fluorescent nonamer ligation. In certain embodiments, the ligation protocol comprises the step of incrementally increasing the ligation reaction temperature from about 20° C. to about 40° C. In another embodiment, macromolecular crowding agents are included in the ligation step. The crowding agents can include polyethylene glycol. In another embodiment, chemical additives which can decrease the Tₘ (melting temperature) difference between A/T and G/C basepairs are included in the ligation step. The chemical additives can include betaine. In another embodiment, nucleotide analogs which can decrease the Tₘ (melting temperature) difference between A/T and G/C basepairs are incorporated into either the query nonomers during synthesis or the template DNA during amplification. The nucleotide analogs can include 2-aminopurine, 2,6-diaminopurine, bromo-deoxyuridine, deoxyinosine, 5-nitroindole, and locked nucleic acids.

In particular, certain embodiments provide polony beads bound directly to a glass support by linkage of the 3′ ends of the oligonucleotides immobilized on the beads to activated —NH₂ groups on the siliconized glass support. The advantages of creating a bead array immobilized directly on a glass substrate are manifold. For instance, the present invention provides for the ability to make a highly dense array in a monolayer. The maximum number of beads that can be successfully arrayed directly on glass is approximately 60,000,000 (65,000 beads per frame, 930 frames per array), which provides as many as 30× more DNA sequences to be obtained from a single slide. The present invention provides for improved chemistry and increased signal to noise ratio due to direct accessibility of reagents to the beads. The present invention also provides for a wider range and greater volume of potential reagents that can be used, including reagents which are incompatible with an acrylamide matrix. The bead array can be imaged more easily because it is in the form of a monolayer and is relatively flat, and the autofocusing procedure will be more automatable.

Certain embodiments are directed to ligation methods for capping the 3′ terminii of single-stranded template DNA that are bound to beads to block further participation in ligation reactions. Advantages of “Capping-by-ligation” include not only improved signal in polony ligation-mediated DNA sequencing by effectively reducing background, but also the ability to attach 3′ amino modifiers with which to attach the DNA-coated beads to glass by NHS ester chemistry. Preferred embodiments include the addition of polyethylene glycol in the ligation reaction, which significantly increases the efficiency of all ligation reactions where one of the oligonucleotides is bound to a solid support.

This invention is further illustrated by the following examples, which should not be construed as limiting. The contents of all references, patents and published patent applications cited throughout this application are hereby incorporated by reference in their entirety for all purposes.

### Example 1

### Stage I. Total RNA Preparation

Total RNA was prepared using Trizol reagent (GibcoBRL). Each library described here was constructed from a total of 10 micrograms of total RNA. We pooled RNA from the tissues of 45 male mice per library (wildtype and αMHC^{403/+} in SvEv background) to minimize inter-animal variability in RNA expression.

### Stage II. cDNA Synthesis

Prepare Dynabeads (mRNA Direct Kit, Dynal), washing solutions, 1st strand mix (keep on ice), before thawing RNA.

Prepare fresh solutions per library. Glycogen (Roche) or BSA (NEB) is used in the following solutions to reduce clumping of dynabeads. 2×BW buffer (10 mM Tris-HCl pH 7.5, 1 mM EDTA, 2.0 NaCl). The following volumes represent the requirements for 1 library.
Buffer A: Washing Buffer A (Dynal)+20 μg/ml glycogen (Roche): 2 mL
Buffer B: Washing Buffer B (Dynal)+20 μg/ml glycogen: 1 mL
Buffer C: IX BW+1% SDS+20 μg/ml glycogen: 3 mL
Buffer D: IX BW+200 μg/ml BSA: 5 mL
Buffer 4 (NEB)+200 μg/ml BSA: 5 mL

Prepare 37° and 160 water bath for subsequent immediate steps.
Thoroughly resuspend Dynabeads oligo (dT)25, transfer 100 μl to an RNAse-free siliconized 1.5 ml tube, and place on magnet. After approximately 30 sec. remove supernatant. Care should be used to prevent disturbing the beads (e.g., place pipette tips at the opposite side of the tube, lower to bottom of tube and pipette very slowly). Resuspend beads in 500 μl lysis/binding buffer. In all washing steps add solutions while the tube is still on the magnetic stand to minimize “drying out” of the beads, then close the cap and remove it from the magnet. Resuspend beads by “flicking” the tube or by gentle vortexing. Remove buffer just prior to use.
Add 10 μg total RNA to 5001 of lysis/binding buffer and incubate with oligodT beads at RT for 10-15 min. on a rocking platform or with intermittent slow vortexing.
Place the tube on magnet for 2 min., then remove supernatant.
Pipetting the beads is more efficient than flicking the tubes in this step.

Wash 2×0.5 ml of washing buffer with Buffer A.
Wash 1×0.5 ml of Buffer B.
Wash 4 times with 10011 of 1×1st strand buffer (dilute 5×1st strand buffer from cDNA synthesis kit with DEPC treated water).

Resuspend beads in 1st strand synthesis mix:

| | | |
|---|---|---|
| DEPC H20 | 55.5 | μl |
| 5x 1st strand buffer | 18 | μl |
| 0.1M DTT | 9 | μl |
| 10 mM dNTP | 4.5 | μl |

Place tube at 37° C. for 2 min, then add 3 μl of Superscript RT. Incubate at 37° C. for 1 hr, mix beads every 10 min. by gentle flicking or slow vortexing. After incubation, place tube on ice to terminate the reaction.

On ice add the components of the 2nd strand synthesis, in order shown, to the first strand reaction:

| | | |
|---|---|---|
| First strand reaction products | 90 | μl |
| water (pre-chilled) | 465 | μl |
| 5x 2nd strand buffer | 150 | μl |
| 10 mM dNTP | 15 | μl |
| E coli DNA ligase | 5 | μl |
| E coli DNA pol I | 20 | μl |
| E coli RNAse H | 5 | μl |

Incubate at 16° C. for 2 hrs, mix beads every 10 min.

### Preheat Buffer C to 75° C.

After incubation, terminate reaction by adding 4511 of 0.5 M EDTA.
Draw off the supernatant, then add pre-heated 0.5 ml of Buffer C, mix well, and heat at 75° C. for 12 min. (with intermittent mixing) to inactivate E. coli DNA polymerase. Remove supernatant and quickly wash again with 0.5 ml of Buffer C.
Then wash 4× Buffer D, 2×200 μl of 1× Buffer4+BSA (transfer to new tubes after first wash).
Take 5 μl of the last wash for checking the integrity of cDNA by RT PCR.

### Stage III. Cleavage of cDNA with Anchoring Enzyme (NlaIII)

Resuspend beads in following mix and incubate at 37° C. for 1 hr:

| | |
|---|---|
| LoTE | 172 μl |
| BSA (100x, NEB) | 2 μl |
| 10x Buffer4 | 20 μl |
| NlaIII (NEB#125S) | 6 μl |

After incubation, wash beads with 2×500 μl of Buffer C (preheated to 37° C., wash quickly before SDS precipitates), then wash 4×200 μl Buffer D (beads can be stored overnight at this stage).

### Stage IV

Ligating Adapter A to cDNA
Wash with 2×200 μl of 1× ligase buffer. At final rinse transfer into a new (siliconized) tube.
Wash 1×50 μl of 1× ligase buffer and leave on ice.
Remove last wash and resuspend beads as follows:

| | |
|---|---|
| LoTE | 11.5 μl |
| 5x ligase buffer | 4 μl |
| Linker EmulSAGEA (annealed) 50 μM | 2 μl |

This ligation of linkers A and B is performed in molar excess of linkers to minimize the formation of library to library dimers (from 2.25 picomoles in conventional SAGE to 100 pmoles in this reaction).
Heat tubes at 50° C. for 2 min. then let sit at RT for 5-15 min, then chill the samples on ice. Add 2.5 μl of T4 ligase (High conc. Life Tech #15224-041) to each tube and incubate at 16° C. for 2 hrs. Mix beads intermittently.
After ligation wash each sample with 200 μl of Buffer D.
Wash 4×200 μl of Buffer D.
Wash 2×200 μl of 1× Buffer2+BSA (transfer to new tubes after first wash).

### Stage V

Release of cDNA-Tags Using Tagging Enzyme AcuI
Prepare fresh diluted SAM. Stock concentration is 32-mM SAM. Mix 1 μl 32 mM SAM into 79 μl 1×NEB 2 Buffer, resulting in a 10×SAM solution (400 μM). Make diluted SAM fresh for each use.
Resuspend beads in the following mix (preheated to 37° C. for 2 min):

| | |
|---|---|
| dH20 | 150 μl |
| 10x buffer2 | 20 μl |
| 10x 400 μM SAM | 20 μl |
| AcuI (NEB) | 10 μl |

Incubate at 37° C. for 2 hrs, mix intermittently. After incubation centrifuge at 14,000 for 2 min. then transfer supernatant to new tube (not siliconized). Wash beads once with 100 μl of LoTE, pool these together (300 μl final volume).

### Stage VI. Ligating Adapter B to Form Library Construct

### Rationale for Adaptor B Ligation:

Products of Adaptor B ligation if allowed to go to completion:

| | |
|---|---|
| AdaptorA-Tag-AdaptorB | 91-bp |
| AdaptorA-Tag-Tag-AdaptorA | 124-bp |
| AdaptorB-AdaptorB | 52-bp |

As the ligation of AdaptorB to the AdaptorA-Tag involves the ligation of 2-bp degenerate overhangs, AdaptorB is provided in molar excess to minimize the formation of AdaptorA-Tag-Tag AdaptorA dimers.
Extract with 300 μl PC8 (Phenol [pH 8.0]:Chloroform, 1:1 (vol.)).
High concentration ethanol precipitate 300 μl aqueous phase with 2 μl of cDNA (do not overdry because you'll lose your DNA).
   Add 2 μl cDNA
   Add 133 μl 7.5M ammonium acetate, mix briefly
   Add 1000 μl 100% EtOH, vortex briefly
   Incubate on dry ice for 10 min.
   Microcentrifuge×30 min. at 4° C.
   Wash twice with 70% ethanol, spin again after last wash, carefully remove residual liquid with pipette tip and resuspend pellet in 2 μl LoTE.
Prepare mixes on ice as follows:

| | |
|---|---|
| 2x Ligase mix | |
| PMAGE library | 2.0 μl |
| Ultrapure dH20 | 2.0 μl |
| 5x Ligase Buffer | 2.0 μl |
| Linker EmulSAGEB (annealed) 50 μM | 2.0 μl |
| T4 Ligase (High Conc) | 2.0 μl |

Incubate overnight at 16° C. Incubation should be performed in a PCR machine/thermal controller with heated lid.
Dilute 10 μl library in 22 μl LoTE+8 μl 5× loading buffer. Divide yield into 4 columns and run on 20% acrylamide TBE gel at 150 V over 3-4 hours and gel extract.
Stain gel using SYBR Green Stain I (Roche #1-988-131): 5 μl SYBR Green in 50 ml of TBE buffer in foil wrapped container; let gel soak in rocker for 15 min)
Visualize on UV box using SYBR green on UV filter.
Notably, only AdaptorA-Tag-AdaptorB (91-bp) and AdaptorB-AdaptorB (52-bp) products are visible. AdaptorA-Tag-Tag-AdaptorA bands are not visible (124-bp).
Given the excess of AdaptorB-AdaptorB products, an additional gel purification step is warranted.
   Cut out only amplified library from gel, and place 2 isolated bands in a 0.5 ml microfuge tube (nine 0.5 ml tubes total), in which the bottom has been pierced with a 21-gauge needle to form a small hole of about 0.5 mm diameter (pierce tubes from the inside-out).
   Place 0.5 ml tubes in 2.0 ml siliconized microfuge tubes (Ambion #12475) and spin at full speed for 4 mins (this serves to break up the acrylamide gel into small fragments at the bottom of the 2.0 ml microfuge tube).
   Discard 0.5 ml tubes, add 250 μl LoTE and 50 μl 7.5M NH₄OAc to each 2.0 ml tube.
   Tubes can remain at this point at 4° C. overnight.
   Then, vortex each tube, and place at 60° C. for 15 min.
   Place 5 μl of LoTE on the membrane of each of 4 SpinX tubes.
   Transfer contents of each tube to 2 SpinX microcentrifuge tubes (2 tubes transferred to 4 SpinX microcentrifuge tubes).
   Spin each SpinX in a microcentrifuge for 5 minutes at full speed.
   Consolidate sets of 2 eluates (300 μl total) and transfer to 1.6 ml tube.
   Ethanol precipitate eluates
      300 μl sample
      3 μl glycogen
      133 μl 7.5M NH₄OAc
      1000 μl 100% Ethanol
   Spin in a microcentrifuge at full speed for 15 min.
   Wash twice with 75% EtOH.
   Resuspend DNA in 10 μl LoTE in each tube
   Pool samples into one tube (20 μl total). Add 5 μl of 5× loading buffer.
   Divide yield into 2 columns and run on 20% acrylamide TBE gel at 150 V over 3-4 hours and gel extract.
   Stain gel using SYBR Green Stain I (Roche #1-988-131): 5 μl SYBR Green in 50 ml of TBE buffer in foil wrapped container; let gel soak in rocker for 15 min)
   Visualize on UV box using SYBR green on UV filter.
Discrete AdaptorA-Tag-AdaptorB (91-bp) and AdaptorB-AdaptorB (52-bp) are visible and well separated. Excise the AdaptorA-Tag-AdaptorB (91-bp) bands and repeat acrylamide gel purification and ethanol purification as described above.
Yield of wild type library construct was 17.0 ng. Given that the template is 91-bp double-stranded DNA, and assuming yield in picomoles=([yield in ng×1000]/[660×#bases]) yield is 0.283 picomoles. Suspended yield in total volume of 283 μl for 1 nM template solution for future use in emulsion PCR. 0.28 picomoles of cDNA library, derived from 10 μg of total RNA, generated sufficient yield to theoretically perform up to 90 experiments (consisting of 5.5 million polonies each). A library constructed from αMHC^{403/+} mice was prepared in parallel, with a yield of 11.9 ng or 0.198 picomoles.

### Stage VII

### Confirmation of Library Template by PCR

Perform PCR using the following ingredients:

| | Per Rxn |
|---|---|
| 10X MGB PCR Buffer | 5 μl |
| DMSO | 2.5 μl |
| 10 mM dNTP mixture | 3.0 μl |
| EmulSAGE F (100 μM) | 2 μl |
| EmulSAGE R (100 μM) | 2 μl |
| dH2O | 33.5 μl |
| Platinum Taq (5 U/μl; GibcoBRL #10966-034) | 1 μl |
| Ligation product (1 nM) | 1 μl |

Perform PCR under following conditions:

| | |
|---|---|
| 1 cycle | 94° C. × 1 min. |
| 25 cycles: | 94° C. × 30 sec., 57° C. × 30 min., 72° C. × 1 min. |
| 1 cycle: | 72° C. × 5 min. |

PCR reaction should be stopped at the minimum number of samples to amplify the complex library template before primers are exhausted. In such case, due to the great similarity of the templates, library molecules are more likely to anneal with another single-stranded library molecule rather than to its exact complementary partner.
A discrete and solitary 91-bp band representing the AdaptorA-Tag-AdaptorB library is present.

The library can be confirmed by TA cloning and Sanger sequencing the PCR product. It is imperative that any confirmatory PCR reaction be performed with dedicated reagents and pipettors, and that these PCR products are not to come in contact with library or emulsion PCR preparation areas. A few molecules of amplified and concentrated library PCR product is theoretically sufficient to contaminate an entire library.

### Stage VIII

### Emulsion PCR and Enrichment.

Performed as previously described in Shendure et al. (2005) Science, Vol. 309. No. 5741, pp. 1728-1732.

### Oligonucleotides Used for PMAGE

SENSE CONSTRUCT: 91 bases, ten base cDNA sequence tag

CCACTACGCCTCCGCTTTCCTCTCTATGGGCAGTCGGTGATCTGAAGCTC
ATG-NNNNNNNNNNAGAGAATGAGGAACCCGGGGCAGTTCAC

### Linker Sequences: Using Hand-Mixed NN Degenerate Bases (25:25:25:25)

EmulSAGEA1 and A2 are annealed to form the Forward adapter, and EmulSAGEB1 and B2 are annealed to form the Reverse Adapter.

EmulSAGEA1:
CCACTACGCCTCCGCTTTCCTCTCTATGGGCAGTCGGTGATCTGAAGCTC
ATG
EmulSAGEA2:
/5Phos/AGCTTCAGATCACCGACTGCCCATAGAGAGGAAAGCGGAGGCG
TAGTGG/3AmM/
EmulSAGEB1:
AACTGCCCCGGGTTCCTCATTCTCTNN
EmulSAGEB2:
/5Phos/AGAGAATGAGGAACCCGGGGCAGTT/3AmM/

### Amplification Primers for Library Verification by PCR:

EmulSAGE F: CCACTACGCCTCCGCTTTCCTCTCTATG
EmulSAGE R: GTGAACTGCCCCGGGTTCCTCATTCT

### Oligonucleotides Used to Load Beads for Emulsion PCR (for Two Libraries):

Unique library-specific sequences are 5′ proximal to the emulsion “Free Forward” primer, therefore not introducing a PCR based bias between libraries:

DualBiotForProx1:
/52-Bio/CCACTACGCCACCGCTTTCCTCTCTATGGGCAGTCGGTGAT
DualBiotForProx2:
/52-Bio/CCCAGTCTTCACTCAGCCCCTCTCTATGGGCAGTCGGTGAT

### Emulsion PCR Primers:

Beads loaded with DualBiotForProxl:

/52-Bio/CCACTACGCCACCGCTTTCCTCTCTATGGGCAGTCGGTGAT
Free Forward: CCTCTCTATGGGCAGTCGGTGAT
Emulsion Reverse: CTGCCCCGGGTTCCTCATTCTCT

### Library-Specific Fluorescent Oligonucleotide Hybridization:

Cy3HybProx1:
/5Cy3/AAAGCGG/ideoxyU/GGCG/ideoxyU/AG/ideoxyU/G
Cy5HybProx2:
/5Cy5/GGC/ideoxyU/GAG/ideoxyU/GAAGAC/ideoxyU/GG

### Polony Sequencing Anchor and Blocking Primers:

Amplified beads identified with Cy3HybProx1:
/5Cy3/AAAGCGG/ideoxyU/GGCG/ideoxyU/AG/ideoxyU/G
ESAcuIA:
/5Phos/CAIideoxyU/GAGC/ideoxyU//ideoxyU/
CAGAIideoxyU/CACCGA
PR1UI0N:
CCCGGG/ideoxyU//ideoxyU/CCUCAIideoxyU//ideoxyU/C/
ideoxyU/CT
block-ESAcuIA: CUUCAGAUCACCGACUGC/3ddC/
biock-PR1UI0N: CUGCCCCGGGUUCCU/3ddC/

### Example 2

### Protocol for Construction of Gel-Less Polony Bead Arrays

Use of an acrylamide matrix for polony array construction interferes with access to bead-bound DNA templates by sequencing reagents due to limiting diffusion. Susceptibility of acrylamide to attack by alkali or dehydration also excludes use of certain reagents (e.g. alcohols, alkaline denaturants, and others) during sequencing cycles. Additionally, beads within the matrix are not uniformly located in a single focal plane, resulting in diminished performance of microscopy based data acquisition with lower yield and signal coherence. Immobilizing polony beads directly to glass resolved these limitations. To increase the number of beads per glass array, to align beads on a monolayer, and to increase the permeability of chemistry reagents, an approach is provided to cross-link amino groups on oligonucleotide-coated beads to aminosilylated glass cover-slips. Glass cover slips are aminosilylated. Then oligonucleotides (both loaded forward primers and amplified templates) on polony beads are capped with primary amines. Reactive amines on oligonucleotide-coated beads and on glass coverslips are bridged with bivalent amino-ester crosslinkers. Capping also serves the dual purpose of decreasing background fluorescence in ligation-based sequencing.

### Materials:

Amplified polony beads
Acetone (water-free)

### 3-Aminopropyltriethoxysilane (Pierce 80370)

### BS3 [Bis(sulfosuccinimidyl)suberate] (Pierce 21580)

3AmM capping oligo:

cap-5Phos-3AmM
(/5Phos/CTGAAGCTCA/3AmM/)

3AmM 9N capping oligo:

cap-9N-5Phos-3AmM
(/5Phos/NNNNNNNNN/3AmM/)

Bridging oligo for bead loading oligo:

cap-ESAcuIA
GUGAGCTUCAGAUCACCGACUGC/3ddCI

Bridging oligo for amplified template:

cap-A-PR1UI0N
GUGAGCTUCAGTCUGCCCCGGGUTC/3ddCI

PBS (pH 7.4)
Tris solution (20 mM, pH 7.5)

### Methods

### Silylation of Glass Surface:

1. Thoroughly wash and dry cover slips.
2. Prepare 2% solution of Aminosilane
1 part 3-Aminopropyltriethoxysilane
49 parts water-free acetone
   3. Immerse glass for 30 seconds in 2% minosilane solution
   4. Rinse 1× in dry acetone
   5. Allow to air-dry in fume hood.
   Cap Oligonucleotides on Beads with Amines:
   1. Wash beads 2× with 200 μl TE, using magnet.
   2. Prepare 200 μl annealing mixture:
192 μl 6×SSPE
4 μl 1 mM cap-ESAcuIA
4 μl 1 mM cap-A-PR1UI0N
   3. Resuspend beads in 200 μl annealing mixture. Mix well.
   4. Incubate tube in a heating block to anneal at 56 C for 10 min. Mix with pipette intermittently.
   5. Wash 3× with 200 μl TE
   6. Resuspend beads in 200 μl ligation mixture, and incubate at RT on a gentle agitator (like Belly Dancer or Waver) for 60 min.
93.3 μl dH20
100 μl 2× Quickligase Buffer
2.7 μl 1 mM cap-5Phos-3AmM oligo
4 μl HC ligase
   7. Place in magnet for 1 min. and remove all liquid.
   8. Resuspend beads in second 200 μl ligation mixture, and incubate at RT on gentle agitator for additional 60 min.
93.3 μl dH20
100 μl 2× Quickligase Buffer
2.7 μl mM cap-9N-5Phos-3AmM oligo
4μ HC ligase
   9. Wash once with 200 μl TE, 1× with 200 μl NX2 buffer, 3× with 200 μl TE.
   10. Denature strands with 2× washes with 200 μl NaOH.
   11. Wash 3× with 200 μl TE. Prior to use, wash 3× with 200 μl PBS (last wash in new siliconized tube.

### Crosslinking:

1. BS3 is very moisture sensitive. Store at 4 C in dessicator. To avoid condensation on the product, allow to equilibrate to room temperature for several minutes before using.

2. Make fresh solution of 5 mM BS3 in PBS (2.86 mg/mL), using the minimum volume that can be accurately weighed.

3. Resuspend beads in 10 μl of 5 mM BS3 quickly (this is time-sensitive) and drop onto coverslip. Place an inverted Teflon-coated slide on top to facilitate beads settling down to the coverslip surface. The time from suspension of beads in BS3 to laying on the slide should be no more than 12 seconds. Incubate for 45 min. at room temp. If removing from a slide holder, let the coverslip/slide settle for 10 min. before inverting and removing the coverslip.

4. The shearing force from removing the slide from the coverslip can disrupt the beads from the coverslip. Carefully separate the coverslip from the slide. Place into the quench solution (20 mM Tris pH 7.5). Gently rinse away extra beads in the quench solution.

5. Rinse coverslip in water, and now ready to assemble into flow cell.

### Example 3

### Protocol for Construction of Gel-Less Polony Bead Arrays

This protocol decreases the formation of secondary bead to bead interactions that can cause loss of yield. The linker is not free in solution and so cannot link beads to each other before they attach to glass. This makes the protocol more robust to variations in handling and easier to practice.

### Materials:

amplified polony beads

### PBS (pH 7.4)

Codelink-treated coverslip. The coverslip is coated with polyethylene glycol. One end of the polyethylene glycol molecule is covalently attached to the coverslip. The other end of the polyethylene glycol molecule bears a linker functional group such as N-hydroxysuccinimide.

### Protocol:

wash beads 3×w/200 ul PBS
resuspend beads in 10 ul PBS
drop beads onto functionalized face of codelink-treated coverslip
immediately place an inverted teflon-coated glass microscope slide on top to spread liquid across array surface
allow to couple for >=8 hours at RT in humidity chamber filled w/PBS
carefully separate the coverslip from the slide
incubate the coverslip in 20 mM Tris (pH 7.5) to quench any remaining reactive groups on coverslip surface

### Example 4

### Sequencing by Ligation Protocol

Sequencing was performed as previously described (1) with the following modifications:

Anchor primers (U = deoxyuridine):
ESAcuIA: /5Phos/CAUGAGCUUCAGAUCACCGA
PR1UI0N: CCCGGGUUCCUCAUUCUCT

Tag sequences which form stable hairpin loops with the template sequence can be under-represented in datasets. This phenomenon is likely attributable to inaccessibility of sequencing oligos. To inhibit hairpin formation, blocking primers are added in the annealing step, such that the blocking primer anneals to the opposite end of the library template from the anchoring primer. Anchor primers were hybridized in the flowcell with the addition of the corresponding blocking primers in equimolar quantities.

Blocking primers (U = deoxyuridine):
block-ESAcuIA: CUUCAGAUCACCGACUGC/3ddCI
(to be used with the PR1 UI0N primer)
block-PR1 UION: CUGCCCCGGGUUCCU/3ddCI
(to be used with the ESAcuIA primer)

Query primers were used as previously described, but 6-FAM was used in the place of FRET for its superior signal in the plus positions and minus 5-6 position. For example, to query the plus 5 position, the following degenerate nonamer mix was used:

| | |
|---|---|
| Cy54NT5 | 5′-Phos/NNNNTNNNN/Cy5--3′ |
| Cy34NA | 5′-Phos/NNNNANNNN/Cy3-3′ |
| TexasRed4NC | 5′-Phos/NNNNCNNNN/TR-3′ |
| FAM4NG | 5′-Phos/NNNNGNNNN/FAM6-3′ |

Ligation with query primers was preceded by priming the flowcell with PEG containing Quick ligase buffer (NEB). Query primers were ligated in the flowcell (8 uM query primer mix (2 Um each subpool), 6000 U T4 DNA ligase (NEB), Ix Quick ligase buffer (NEB). Institution of PEG for macromolecular crowding increases the kinetics of the ligation reaction, thus increasing signal.

We used multiple ligation temperatures, implemented as a stepped gradient, to improve annealing of all degenerate query nonomers, given their broadly disparate melting temperatures. By incrementally increasing the ligation reaction temperature from 18 C to 37 C (close to the maximum permissible temperature for T4 DNA ligase), a greater subset of degenerate sequence will hybridize to the template and thus fluorescently-tag the bead by ligation. Our protocol is for ligation at 18 C for 5′, then at 25 C for 5′, then 30 C for 5′, then 37 C for 5′ to more thoroughly cover the Tm space of all degenerate query nonomers. At the end of the reaction, excess query primer was washed out at room temperature with Wash 1 E for 5′.

After completing all sequencing cycles, the array is hybridized with library-specific fluorescent oligonucleotides (See end of Note S 1 for primer sequences). 4 μl of each 100 mM primer is mixed with 192 μl of 6×SSPE. Primer hybridization is performed as previously described.

Stripping was performed as previously described in Shendure et al. (2005) Science, Vol. 309. No. 5741, pp. 1728-1732.

### Example 5

As an additional measure to reduce background, free forward primer can be removed from beads after they have been coupled to the array in a sequence-specific manner using Exonuclease I to selectively degrade single-stranded DNA strands.

Steps for removing forward primer are as follows:

Begin by hybridizing a ‘protecting’ oligonucleotide complementary in sequence to the 3′ end of the strands which should not be degraded. Then incubate with Exonuclease I under conditions suitable for 3′->5′ exonucleolysis of all strands to which the protecting oligonucleotide has not annealed. Since Exonuclease I can only initiate digestion from a single-stranded 3′ end, it will not degrade those strands annealed to a ‘protecting’ oligonucleotide. Following Exonuclease I treatment, inactivate and remove the enzyme by incubating in 6M guanidinium HCl for 1 minute at RT followed by several rinses in dH2O and Wash 1.

### Example 6

The accuracy of reported tag counts is improved by modifying the ligation protocol to address underlying reaction inefficiencies.

“Stepped temperature” ligation reactions are performed to more thoroughly cover the Tₘ space of all degenerate query nonamers used, which ranges from 16° C. (AAAAAAAAA) to 50° C. (GGGGGGGGG) according to the equation:

$$TM = \frac{deltaH}{A + deltaS + R ln ( [ oligo ] / 4 )} - 273.15 + 16.6 log [ Na + ]$$

By incrementally increasing the ligation reaction temperature from 20° C. to 40° C. (the maximum permissible temperature for T4 DNA ligase), a greater subset of degenerate sequence will hybridize to the template and thus fluorescently-tag the bead by ligation. In addition, macromolecular crowding agents, including polyethylene glycol, can be used to increase the kinetics of the reaction, resulting in more signal per bead. Chemical additives, including betaine, can be used to decrease the Tm differential between A/T and G/C basepairs. Nucleotide analogs, including 2-aminopurine, 2,6-diaminopurine, bromo-deoxyuridine, deoxyinosine, 5-nitroindole, and locked nucleic acids, can be incorporated into either the query nonamers during synthesis or the template during amplification to modulate the Tₘ differential.

In light of the foregoing disclosure of the invention and description of various embodiments, those skilled in this area of technology will readily understand that various modifications and adaptations can be made without departing from the scope and spirit of the invention. All such modifications and adaptations are intended to be covered by the following claims.

What is claimed is:

1. An array comprising a plurality of beads and a solid support, wherein each bead comprises oligonucleotides immobilized on the surface of the bead, and wherein each bead is connected to the solid support by at least one molecule on the bead which can bind to a corresponding molecule on a surface of the solid support.

2. The array of claim 1, wherein the beads are polony beads.

3. The array of claim 1, wherein the beads are arranged in a uniform layer of one bead thickness.

4. The array of claim 1, wherein the solid support is glass, metal, ceramic, or plastic.

5. The array of claim 1, wherein the each bead is connected to the solid support by at least one tether molecule covalently attached to both the surface of the solid support and to an oligonucleotide immobilized on the bead.

6. The array of claim 5, wherein the tether molecule is a linker selected from the group consisting of amino esters, bis(sulfosuccinimidyl)suberate (BS3), N-hydroxysuccinimidyl (NHS), N-(κ-maleimidoundecanoyloxy)sulfosuccinimidyl (KMUS), N-ε-maleimidocaproyloxy)succinimidyl (EMCS), iodoacetamide, dithiol, nitrobenzyl, and mixtures of any of them.

7. The array of claim 5,
wherein the tether molecule is selected from the group consisting of polyethylene glycol, poly(N-vinyl lactams), polysaccharides, polyacrylates, polyacrylamides, polyalkylene oxides, and copolymers of any of them; and
wherein the tether molecule is covalently attached to at least one oligonucleotide immobilized on the bead through a linker selected from the group consisting of amino esters, bis(sulfosuccinimidyl)suberate (BS3), N-hydroxysuccinimidyl (NHS), N-(κ-maleimidoundecanoyloxy)sulfosuccinimidyl (KMUS), N-(ε-maleimidocaproyloxy)succinimidyl (EMCS), iodoacetamide, dithiol, nitrobenzyl, and mixtures of any of them.

8. The array of claim 1, wherein each bead is bound to an amino-silylated glass support through at least one oligonucleotide having an —NH₂ group at its 3′ terminus, the —NH₂ group at 3′ terminus being covalently attached to bis(sulfosuccinimidyl)suberate (BS3), and the BS3 being covalently attached to an —NH₂ group on a surface of the amino-silylated glass support.

9. The array of claim 1, wherein each bead is bound to a glass support through at least one oligonucleotide having an —NH₂ group at its 3′ terminus, the —NH₂ group at the 3′ terminus being covalently attached to N-hydroxysuccinimide (NHS), the NHS being covalently attached to polyethylene glycol (PEG), and the PEG being covalently attached to a surface of the glass support.

10. A method for producing an array comprising the steps of:
a) providing a plurality of beads, wherein each bead comprises oligonucleotides immobilized on the surface of the bead,
b) providing a solid support;
c) connecting the plurality of beads to the solid support by binding at least one molecule on a bead to a corresponding molecule on a surface of the solid support.

11. The method of claim 10, wherein the beads are polony beads.

12. The method of claim 10, wherein the connecting step of step c) comprises covalently attaching a tether molecule to a surface of the solid support and to an oligonucleotide immobilized on a bead.

13. The method of claim 10,
wherein the solid support of step b) comprises a glass support comprising tether molecules covalently attached to the surface of the glass support, wherein the tether molecules comprise linker functional groups; and
wherein the connecting step of step c) comprises covalently attaching at least one oligonucleotide immobilized on a bead to a linker functional group.

14. A method for DNA sequencing, comprising the steps of:
a) providing a plurality of beads, wherein each bead has immobilized on the surface thereof single-stranded template DNA having a 3′ terminus;
b) annealing a first oligonucleotide to the 3′ terminus of the template DNA, wherein the first oligonucleotide comprises a 5′ overhanging sequence;
c) annealing a second oligonucleotide to the 5′ overhanging sequence, wherein the second oligonucleotide comprises a 3′ blocking moiety; and
d) ligating the second oligonucleotide to the template DNA;
e) providing a solid support;
f) forming an array by connecting the plurality of beads to the solid support;
g) performing DNA sequencing on the array.

15. The method of claim 14, wherein the beads are polony beads.

16. The method of claim 14, wherein the DNA sequencing step of step g) comprises the steps of
h) annealing to the template DNA a sequencing primer and a degenerate oligonucleotide comprising a fluorescent tag; and
i) ligating the sequencing primer to the degenerate oligonucleotide.

17. The method of claim 16, wherein step i) further comprises ligating with the inclusion of polyethylene glycol in the ligation reaction.

18. The method of claim 16, wherein step i) further comprises ligating at incrementally increasing temperatures from about 20° C. to about 40° C.

19. The method of claim 16, wherein step i) further comprises ligating at 18° C. for five minutes, then at 25° C. for five minutes, then at 30° C. for five minutes, and then at 37° C. for five minutes.

20. The method of claim 16, wherein step i) further comprises ligating with the inclusion of at least one compound having the property of decreasing the difference in melting temperature between A/T and G/C base pairs.

21. The method of claim 20, wherein the compound is betaine.

22. The method of claim 14, wherein step d) further comprises ligating with the inclusion of polyethylene glycol in the ligation reaction.

23. The method of claim 14, further comprising the step of removing free forward primer after step f).

24. The method of claim 14, wherein the template DNA, or the degenerate oligonucleotide comprising a fluorescent tag, further comprises nucleotide analogs having the property of decreasing the difference in melting temperature between A/T and G/C base pairs.

25. The method of claim 24, wherein the nucleotide analogs are selected from the group consisting of a 2-aminopurine, a 2,6-diaminopurine, bromodeoxyuridine, deoxyinosine, 5-nitroindole, locked nucleic acids, and mixtures of any of them.

26. The method of claim 14, wherein the 3′ blocking moiety is selected from the group consisting of an amino-modifier, a dideoxycytidine, a non-ribose, a covalent blocking group, a steric blocking group, a reversible blocking group, and mixtures of any of them.

27. The method of claim 14,
wherein the 3′ blocking moiety is an amino-modifier;
wherein the solid support is an amino-silylated glass substrate; and
wherein the connecting step of step f) comprises covalently attaching a tether molecule to the amino-silylated glass substrate and to an amino-modified template DNA resulting from step d).

28. The method of claim 14,
wherein the 3′ blocking moiety is an amino-modifier;
wherein the solid support is a glass support comprising tether molecules covalently attached to the surface of the glass support, wherein the tether molecules comprise linker functional groups; and
wherein the connecting step of step f) comprises covalently attaching a linker functional group to an amino-modified template DNA resulting from step d).
